(19) United States
(12) Patent Application Publication
(10) Pub. No.: US 2022/0137271 A1
(43) Pub. Date: May 5, 2022

(54) OPTICAL ELEMENT HAVING A RANDOMIZING DIGITAL LENS ARRAY AND/OR A DIFFUSER FUNCTION

(71) Applicant: Luminit LLC, Torrance, CA (US)

(72) Inventors: Anthony Ang, Torrance, CA (US); Alejandro Israel Martin, Torrance, CA (US)

(21) Appl. No.: 17/455,820

(22) Filed: Nov. 19, 2021

Related U.S. Application Data
(62) Division of application No. 16/679,119, filed on Nov. 8, 2019.
(60) Provisional application No. 62/758,300, filed on Nov. 9, 2018.

(51) Int. Cl. G02B 5/02; G02B 3/00

(52) U.S. Cl. CPC G02B 5/0278; G02B 5/0268; G02B 3/0056; G02B 3/0012; G02B 3/005

(57) ABSTRACT

This application discloses an optical element having a refractive lens array and a diffuser, both positioned on the same side of the optical element. A method of manufacturing such an optical element is also described herein.

### CROSS-REFERENCE TO RELATED APPLICATION

This application is a divisional of pending U.S. patent application Ser. No. 16/679,119, filed Nov. 8, 2019, and claims priority to U.S. Provisional Patent Application Ser. No. 62/758,300, filed Nov. 9, 2018, whose disclosures are incorporated herein by reference.

### TECHNICAL FIELD

This application is directed to an optical element having a refractive lens array and/or a diffuser function. Specifically, this application relates to an optical element having a refractive lens array with a randomizing feature or with a randomizing feature positioned on the same side of the optical element. Single and double pass methods of manufacturing such an optical element are also described herein.

### BACKGROUND

Past attempts to create a regular lens array with a diffuser whose diffusion angle exceeds the order angle have many disadvantages, such as having the lens array on one side of the optics and the diffuser on the other side of the optics. This process necessitated having the diffuser algorithm as part of the lens array and altering the physical parameters of the individual array elements, such as height, lateral centering, and lens sizes, which optimization is done via computer. This manufacturing technique is computationally intensive and difficult to accomplish without a large memory buffer or on-the-fly randomization of the individual array elements. In the process of designing a refractive lens array to create a custom radiant intensity distribution, a regular array forms multiple orders corresponding to the Grating equation. This is problematic when using a laser where the distribution needs to be uniformly lit and without diffractive orders. Thus, there exists a need for an effective solution to the problem of designing and manufacturing a refractive lens array having a diffuser to provide uniform illumination without sacrificing efficiency, which the present application addresses.

### SUMMARY

The present application is directed to an optical element comprising a micro lens array of lenslets and a randomizing function wherein both the micro lens array of lenslets and the randomizing function reside on the same surface of the optical element; wherein the micro lens array comprises identical lenslets arrayed in both an X and a Y direction; and wherein the randomizing function is an overlaid diffuser.

In one embodiment of the optical element, distances of lens neighbor centers or pitch are identical in the X direction.

In one embodiment of the optical element, distances of lens neighbor centers or pitch are identical in the Y direction.

In one embodiment, the optical element comprises a substrate comprising one or more layers comprising a plastic, a metal, a silicon wafer, or a glass plate.

In one embodiment of the optical element, the metal substrate or reflective optical coating on a metal, a plastic, a silicon wafer, or a glass plate makes the diffusing element a reflective diffuser.

In one embodiment of the optical element, a diffusion angle of the diffuser exceeds an order angle.

In one embodiment of the optical element, the size of a lenslet ranges from about 1 micron to about 1 mm.

In one embodiment of the optical element, the size of the micro array has an upper limit of about 500 mm by 300 mm or by tooling surface.

In one embodiment of the optical element, a surface profile of the lenslet is functionally refractive, diffractive, transmissive or reflective.

In one embodiment of the optical element, an individual lenslet sag ranges from about 1 micron to about 100 micron.

In one embodiment of the optical element, the lenslet sag is spherical, parabolic, hyperbolic, ellipse, aspheric or biconic.

In one embodiment of the optical element, the diffuser has a Gaussian function wherein distribution comprises 30 degrees full width half maximum or less.

In one embodiment of the optical element, distribution comprises flat top, deterministic, super gaussian, line generator, batwing or asymmetric to achieve very high uniformity of light.

In one embodiment of the optical element, the fullwidth at half maximum of the diffuser is greater than angular spacing of diffractive orders.

In one embodiment, the optical element comprises a flat top diffuser with rectangular, square, elliptical, circular, hexagonal, and other geometric shapes.

In one embodiment of the optical element, the micro lens array is a lenticular lens array or an anamorphic lens array.

In one embodiment of the optical element, the diffuser comprises a diffusing angle ranging from 5° to 80°.

In one embodiment, the optical element comprises a refractive lens array and a diffuser wherein light utilization is maximized by directing light where needed and where light uniformity is increased by eliminating hot spots.

In one embodiment, the optical element comprises convolution with a light shaping diffuser pattern.

In one embodiment of the optical element, the micro lens array comprises convolving a comb function with a Gaussian function in angular space.

In one embodiment, the optical element further comprises a coherent or incoherent light source whose emitted light is diffused, shaped, and customized by application of the optical element.

### BRIEF DESCRIPTION OF THE DRAWINGS

FIG. 1 shows Snell's Law and the Law of Refraction.

FIG. 2 shows Lens Sag.

FIG. 3 shows Spherical Sag.

FIG. 4 shows Parabolic Sag.

FIG. 5 shows Hyperbolic Sag.

FIG. 6 shows Ellipse Sag.

FIG. 7 shows Oblate Elliptical Surface.

FIG. 8 shows a Diffraction Grating.

FIG. 9 shows Comb Function.

FIG. 10 shows Convolution of Comb and Gaussian.

FIG. 11 shows Light Shaping Diffuser Surface Relief Function.

FIG. 12 shows Lenticular Lens Array.

FIG. 13 shows Anamorphic Lens Array.

FIG. 14 shows Texture Model of Light Shaping Diffuser.

FIG. 15 shows Scanning Electron Microscope of Light Shaping Diffuser.

FIG. 16 shows Microscope Image vs. Model.

FIG. 17 shows Geometrical model in Zemax.

FIG. 18 shows Off Axis incident.

FIG. 19 shows Slice Plot in Zemax.

FIG. 20 shows reflections 60 degrees incident.

FIG. 21 shows a log plot reflection 60 degrees incident.

FIG. 22 shows a regular micro lens array.

FIG. 23 shows a randomized diffuser surface of a light shaping diffuser.

FIG. 24 shows idealized distribution of 65×28 degrees fwhm radiant intensity plot.

FIG. 25 shows Idealized slice plot of 65 degrees direction.

FIG. 26 shows a wireframe plot of Lenticular Array of lenses.

FIG. 27 shows the edge of a regular Lenticular Array of lenses.

FIG. 28 shows a Lenticular Array of lenses with variable scaled lenses.

FIG. 29 shows a Figure of Measured Lenticular Flat Top Diffuser performance BSDF with some diffraction effects.

FIG. 30 shows a measured flat top diffuser performance.

FIG. 31 shows a measured flat top diffuser performance.

### DETAILED DESCRIPTION

Light from sources such as lasers, diodes, bulbs, etc. has characteristic radiant intensity distributions that are dependent on the source geometry. Optical elements, as described herein, can modify those radiant intensity distributions to adapt these light sources for specific applications. The optical elements described herein diffuse and shape the light by (i) maximizing light utilization by directing more light where needed and (ii) increasing uniformity of the light by eliminating hot spots. Also, the optical elements here provide custom light distributions that can be optimized to specific detection needs, such as 3D sensing and LIDAR. Furthermore, distributions other than gaussian can be achieved using these optical elements (e.g. flat top diffusers, deterministic, super gaussian, line generator, batwing, asymmetric, etc.) to achieve very high uniformity of the light.

The present application relates to an optical element including randomizing digital lens array and methods of manufacturing the same. In one embodiment, an optical element includes a micro lens array of lenslets and a randomizing function wherein both the micro lens array of lenslets and the randomizing function reside on the same surface of the optical element; wherein the micro lens array comprises identical lenslets arrayed in both an X and a Y direction; and wherein the randomizing function is an overlaid diffuser. In another embodiment, the distances of lens neighbor centers or pitch are identical in the X direction. In yet another embodiment, the distances of lens neighbor centers or pitch are identical in the Y direction. In another embodiment, the diffusion angle of the diffuser exceeds the order angle, which in Fourier Optics is known as convolution.

In a different embodiment, an optical element includes a micro lens array of lenslets and a randomizing function where both the micro lens array of lenslets and the randomizing function reside on the same surface of the optical element and wherein the randomizing function is provided by scaled lenslets in a one dimensional cylindrical or lenticular arrangement. In another embodiment, an additional randomizing function is provided by an overlaid diffuser. In yet another embodiment, the micro lens array includes scaled lenslets in a two-dimensional crosshatch pattern. In still another embodiment, an additional randomizing function can be provided by an overlaid diffuser.

In yet another different embodiment, an optical element encompassed a micro lens array of lenslets and a randomizing function where both the micro lens array of lenslets and the randomizing function reside on the same surface of the optical element wherein the randomizing function is provided by randomly alternating concave and convex lenslets in a sinusoid-like pattern in a one dimensional cylindrical or lenticular arrangement. In another embodiment, an additional randomizing function is provided by an overlaid diffuser.

In the optical element described herein, the size of the lenslets range from about 1 micron to about 1 mm. The size of the array has upper limit of about 500 mm by 300 mm. The surface profile of the lenslet can be refractive, diffractive, aspheric, conic, biconic, or anamorphic. The individual lenslet sag can be in the range of about 1 micron to about 100 micron.

One of the features of the optical element herein is to diffuse and shape the light from an incoming (generally collimated) to a desired intensity distribution (bidirectional scatter distribution function, BSDF) in angular space [Radiant Intensity (electro-magnetic spectrum, radiometric) or Luminous Intensity (human visual, photometric)] or in projected space [(Irradiance, radiometric) or (Illumination/Illuminance, photometric)]. For diffusers such as those claimed herein, this is naturally a Gaussian function in most cases where the distribution is 30 degrees full width half maximum (fwhm) or less. However, some optical systems require the distribution be more uniform (flat top). Whether it is rectangular, square, elliptical, circular, or other lateral shapes, in which case LSMs are employed to accomplish the task.

Shaping the BSDF is done utilizing a micro lens array. The shape of the distribution is dependent upon the geometric shape of the individual micro lenses. The geometric ray direction can be calculated using Snell's law in optics where the angle of refraction is determined by the formula:

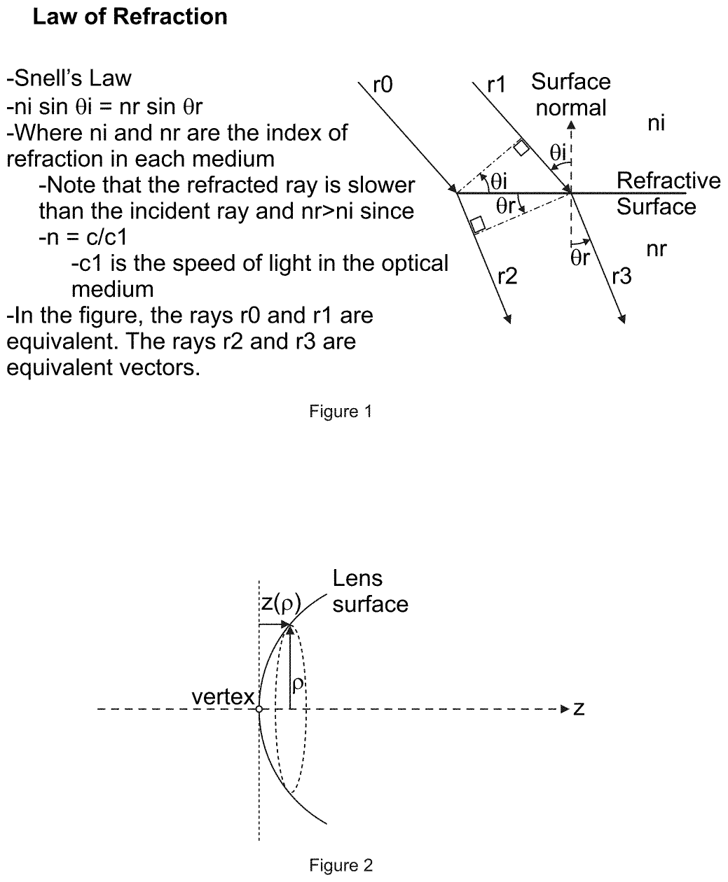

n₁ sin q₁=n₀ sin q₀

where n is the index of refraction and q is the angle with respect to the surface normal. FIG. 1 is a graph illustrating the Law of Refraction and Snell's Law. Many rays (1 million to 100 million) can be traced using a commercially available ray tracing software such as Zemax®.

### Aspherical Lenses

Generically, lenses can take on the Aspheric form, where the z depth of the lens, known as lens sag, graphically shown in FIG. 2. The Aspheric form is used when the lens is required to be rotationally symmetric by the following equation:

Sag z(r)=cr²/(1−sqrt{1−[k+1][cr]²})+Ar²+Br⁴+Cr⁶+Dr⁸+ . . .

The curvature c=1/R. R being the radius of curvature.
The radial distance from the z axis, r=sqrt(x²+y²).
The terms A, B, C, D . . . are the coefficients to higher order aspheric modifications. The term k is known as the conic constant. If the higher order aspheric terms A, B, C, D . . . are zero, then the sag cross section would be:
k=0, circle
k=−1, parabola
k<−1, hyperbola
−1<k<0, ellipse
k>0, oblate ellipse
The conic constant k does not flip sign when making c change sign. The conic does not change value when scaling.
The aspheric coefficients scale and flip sign with c the curvature.

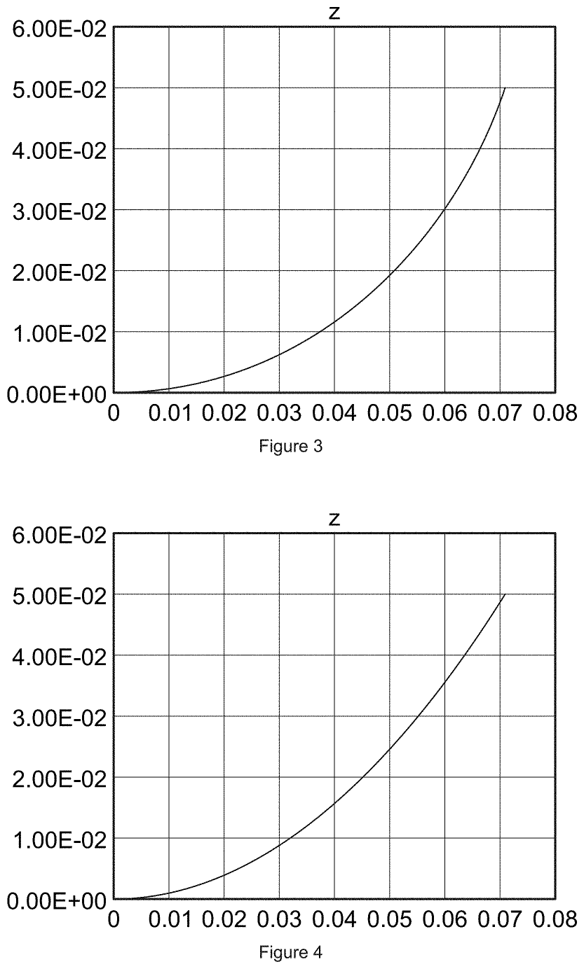

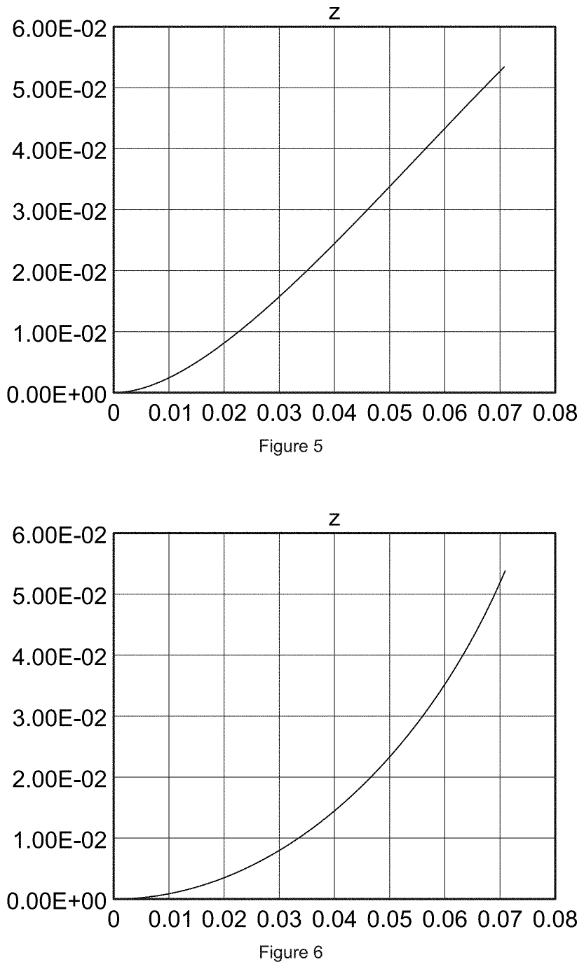

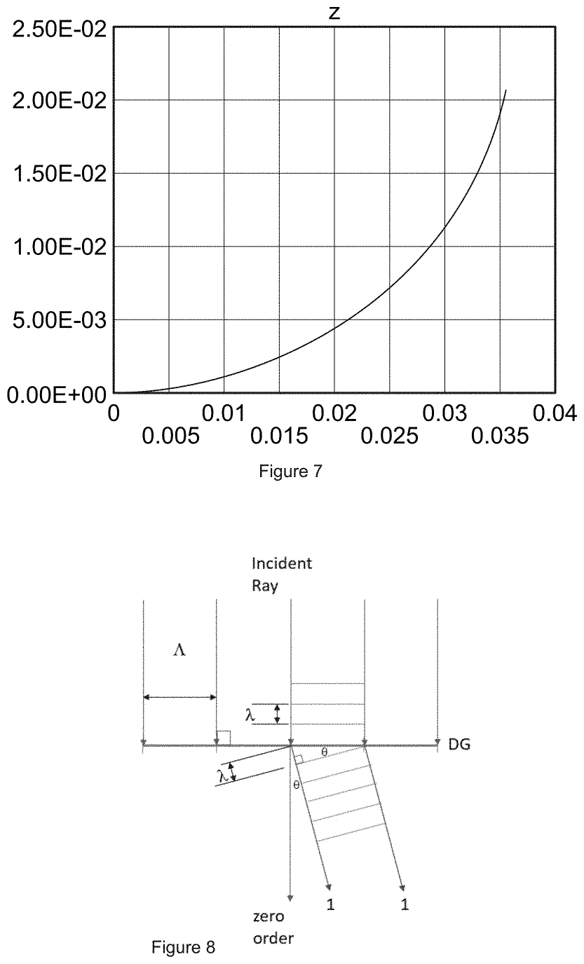

Dz(r)=SB(r/S)^{N}
B=original coefficient
S=scaling factor
N=exponent of the aspheric term
FIG. 3 shows Spherical Sag. FIG. 4 shows Parabolic Sag. FIG. 5 shows Hyperbolic Sag. FIG. 6 shows Ellipse Sag. FIG. 7 shows Oblate Elliptical Surface.

### Anamorphic/Biconic Lens

Another embodiment of a lens is the Anamorphic lens, which has a different shape in the X than the Y direction. In Zemax® it is known as a “Biconic” surface and is described by the following equation.

Sag z(X,Y)=(c_{X}X²+c_{Y}Y²)/{1+sqrt[1−(1+k_{X})(c_{X}X)²−(1+k_{Y})(c_{Y}Y)²]}

The higher order aspheric terms are dropped since they do not scale in the two directions. The conic factors k_{X} and k_{Y} are also different in each direction. Notice that when c^{X}=c^{Y} and r²=X²+Y², that this matches the Aspheric lens formula minus the higher order terms. When scaling, the R_{X} and R_{Y} are changed. Where c_{X}=1/R_{X} and c_{Y}=1/R_{Y}. The conics do not change when scaling.

### Diffraction Effect

As described herein, a micro lens array is employed when the light source is incoherent. This array can also be used with coherent (laser) light. However, a regularly spaced pattern, such as with regularly spaced micro lens array, will create a diffraction pattern, wherein the output light will have regularly spaced orders contained within an envelope of distribution. For this reason, a randomizing factor needs to be introduced into the micro lens array to avoid the diffraction orders. FIG. 8 shows a drawing of the wavefront associated with the ray direction.

### The Grating Equation is:

sin (fₘ)=sin (fᵢ)+ml/L
q=ml/L
l=Wavelength of the light
L=grating Period
m=Order number
fᵢ=incident angle
fₘ=resultant angle from order m
   In this case fᵢ the incident angle to the diffraction normal vector is shown as zero to illustrate the equation.

Also, a diffractive optical element (DOE), known as a computer-generated hologram (CGH) can also create a controlled distribution in angular space for coherent light but not for incoherent light. The thickness should be matched to the lasers wavelength, or the pattern will have an undesired zero order if there are fabrication variations or if the design is inefficient.

### Randomizing Factor

One embodiment of this optical element is to combine the randomizing aspect of a Light Shaping Diffuser with the regular micro lens array to remove the effects of the diffractive orders through the process of convolution. Another embodiment of this invention will scale the lenses to different sizes. This randomizes the frequency of the array. Another embodiment randomizes the direction of the lenses, to alternating convex and concave lenses.

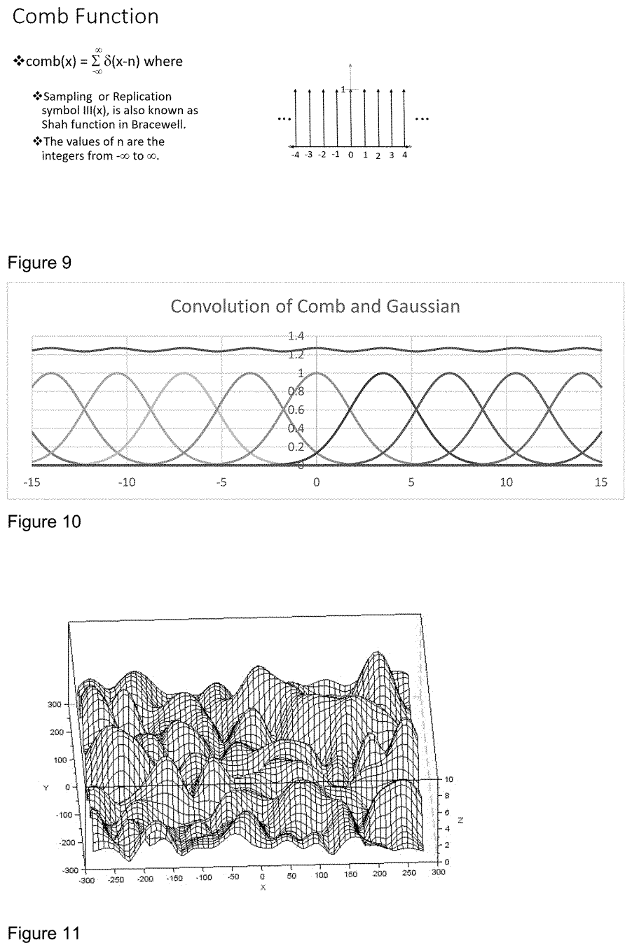

The present optical element includes convolution with a light shaping diffuser pattern. Mathematically, randomizing the micro lens array BSDF involves convolving a comb function (diffractive orders) with a Gaussian function (light shaping diffuse) in angular space. Convolution is a process in which one function smooths out the other. A Gaussian filter in image manipulation software such as Photoshop® can be used. Utilizing Fourier Transform theory, the optical element needs to form a comb (diffractive orders) with a rectangular distribution (desired BSDF) and multiplied by a Gaussian, as shown in FIG. 9, below. In the Comb function, FT {Comb}=comb; FT {lens}=rectangle; FT {Gaussian}=Gaussian; and FT {G×H}=Convolution (G, H)=G*H.

FIG. 10 shows a graph of the convolution of Comb and Gaussian. The Light Shaping Diffuser function is a phase function mask exp[j2pfLSD(x,y)], where j=sqrt(−1), and f(x,y) is the phase function. Since the micro lens array can also be thought of as a phase mask, the combination is a multiplication of the two terms, as shown in the equation below:

Mask(x,y)=exp[j2pfMLA(x,y)]×exp[j2pfLSD(x,y)]=exp[j2p{fMLA(x,y)+fLSD(x,y)}]
Where G(x,y)=exp[j2pfMLA(x,y)], micro lens array expression
And H(x,y)=exp[j2pfLSD(x,y)], Light Shaping Diffuser expression
FIG. 11 shows a diagram of the Light Shaping Diffuser relief function. To multiply the 2 functions the phases are added inside the exponent. This would mean that the convolution of the two terms would take place of their individual Fourier Transforms. The fwhm spread of the Light Shaping Diffuser must be greater than the angular spacing of the diffractive orders.

In one embodiment, a method of manufacturing an optical element includes having a regular micro lens array and a diffuser on a same surface of the optical element by creating the regular micro lens array and the diffuser function in two separate passes on a same surface and side of the optical element. Equipment needed for the manufacturing process includes an image setter and a holographic set up. The optical element can be made of glass, metal, plastic plate or a combination thereof and can be made of one or more layers. The plate can be coated with a photo-resist material. In another embodiment, the method of manufacturing can be a monolithic method that does not require a coating.

The method of creating the regular lens array and the diffuser function in two separate passes can be accomplished by one or more of several different processes, which are listed below:
(A) exposing the lens array, developing the plate, exposing the digital diffuser pattern, and developing the plate a second time;
(B) exposing the lens array, exposing the digital diffuser pattern, and developing the plate;
(C) exposing the digital diffuser pattern, developing the plate, exposing the lens array, and developing the plate a second time;
(D) exposing the digital diffuser pattern, exposing the lens array, and developing the plate;
(E) exposing the lens array, developing the plate, and holographically exposing the diffuser pattern;
(F) holographically exposing the diffuser pattern, developing the plate, and exposing the lens array;
(G) exposing the lens array, making a replicate, coating a photoresist layer on the replicate, and holographically exposing the diffuser pattern; and
(H) holographically exposing the diffuser pattern, making replicate, coating a photoresist layer on the replicate, and exposing the lens array.

This method pertains to refractive flat top uniform diffuser patterns with rectangular, square, elliptical, circular, hexagonal, and other geometric shapes without resorting to computer-generated holography. The method also can be used on non-flat top but shaped amplitude distributions.

Method of Making a Micro Lens Array Having a Surface Relief Pattern with Lithographic Process

To create a surface relief pattern, a light sensitive photo-resist material (PR), is deposited in a liquid state, on a flat substrate such as a plastic, a silicon wafer, or a glass plate. The plate is then spun so that the desired thickness of the PR is achieved. The spun plate is then baked so that the coating becomes solid. It is then exposed to light, at which wavelength PR is sensitive to, which changes the state of the material, conforming to the light pattern. The typical form is in the range of about 1 mJ/cm² to about 2000 mJ/cm², depending upon depth desired. A chemical bath is used to develop the coating. The chemical solution is agitated across the plate for a time period of about 30 sec to about 9 minutes, then mixed with a basic solution having a strength of 0.25% to 1% by weight (sodium hydroxide mixed with deionized water).

Method of Making a Micro Lens Array Having an Analog Pattern with Holographic Process

To create an analog pattern a laser light source is used along with optics, such as lenses, diffuser and mirrors; shutter and mechanical stages; and a computer program to control stage movement and shutter/beam modulation. A speckle pattern is exposed onto the PR-coated plate with a spread beam pattern, of the desired characteristics to achieve the LSD fwhm angle. A digital pattern is first designed on a computer. The file is an image file or 3D type file. The machine exposes the PRM with a focused laser beam on the order of microns or sub microns.

### Differences Between Analog and Digital

Digital has advantage of having full control of the pattern. The analog formed light shaping diffuser can be controlled to a given angle (fwhm), but the shape of distribution (i.e. Gaussian) cannot be controlled. The digital light shaping diffuser pattern can be achieved by capturing the surface relief pattern of the analog light shaping diffuser. On the other hand, Analog has the advantage of speed, in which the formation of the pattern is much faster to produce the LSD.

### Scaling Lenses

As described in the randomizing process, scaling of the lens size can be utilized. The aspect ratio between the radius of curvature and aperture size must be conserved when scaling. This allows the surface slope distribution and hence the BSDF, to be maintained. With the Biconic form of lens, only the Radius, needs to be scaled w.r.t. the aperture size in the direction of interest.

With the Aspheric form, the radius and higher order aspheric terms can be scaled. Care must be taken to scale the higher order terms. The conic constant should never be scaled, as it dictates the shape of the lens.

### Flipping Lens Direction

As described in the randomizing process, flipping the lens involves:
I) Changing the sign of the radius and hence the sign of the curvature;
II) Changing the sign of the higher aspheric terms
III) Never changing the sign of the conic constant.

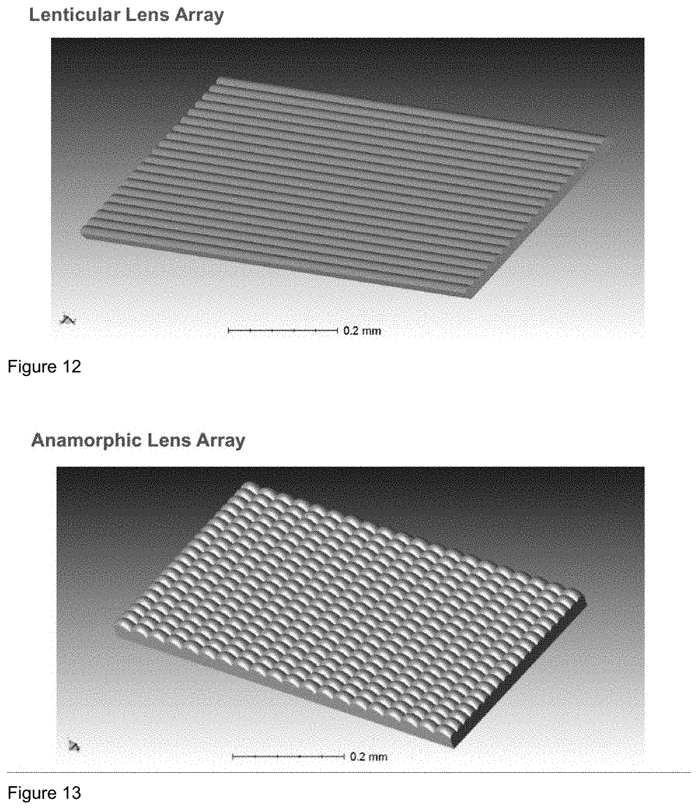

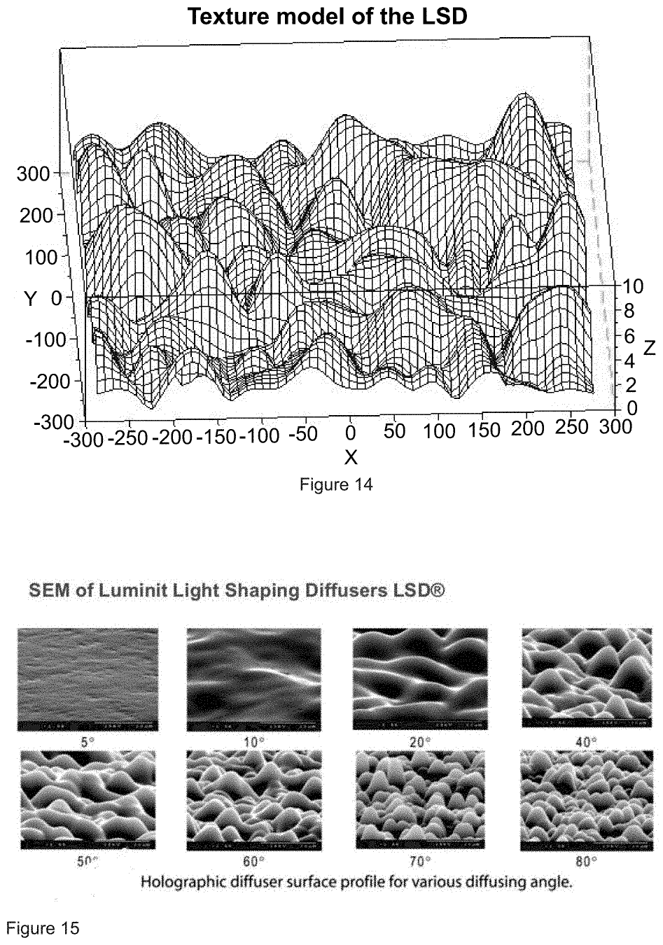

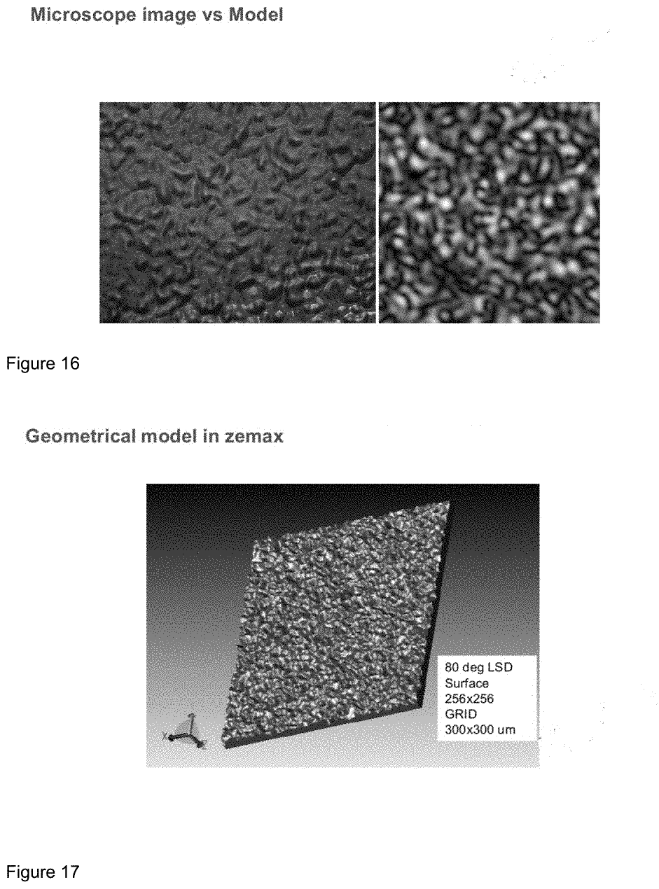

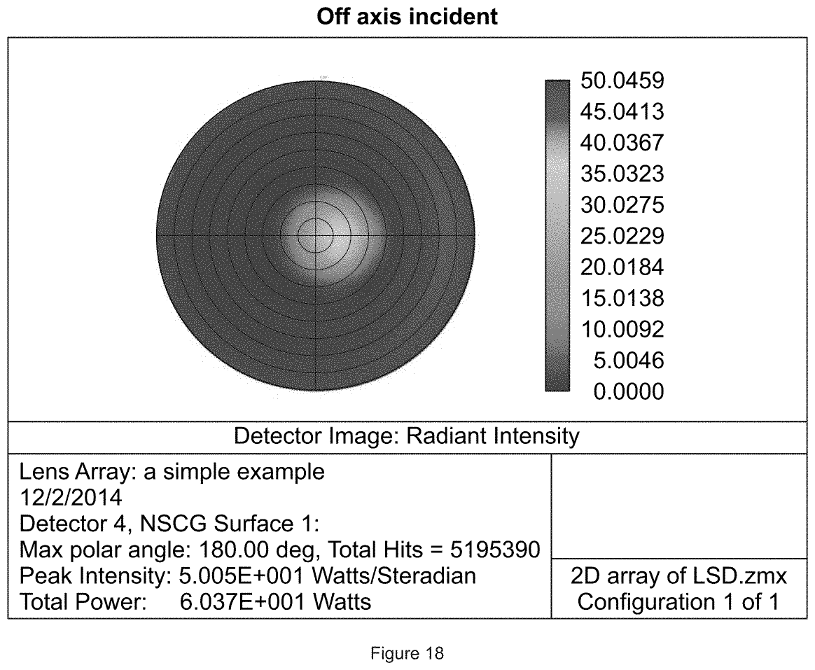

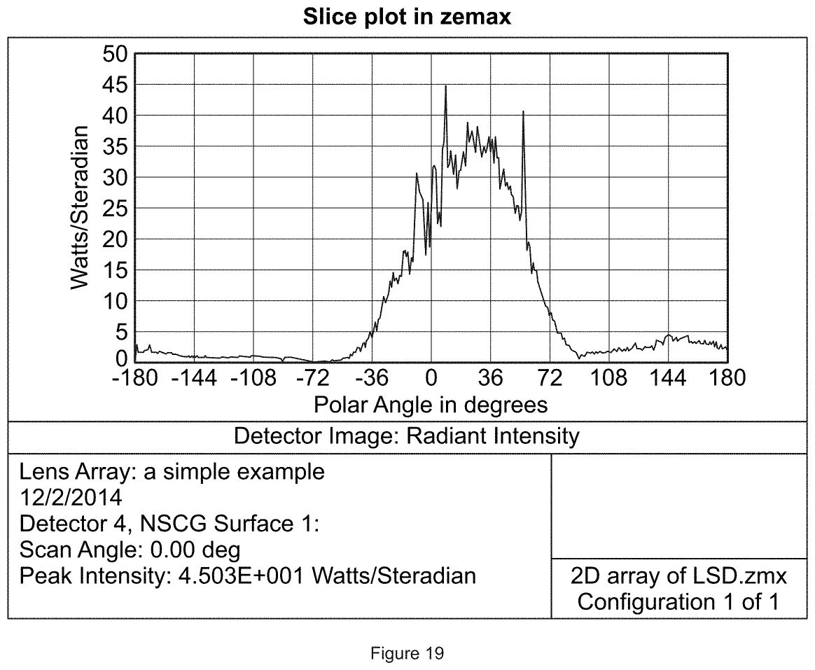

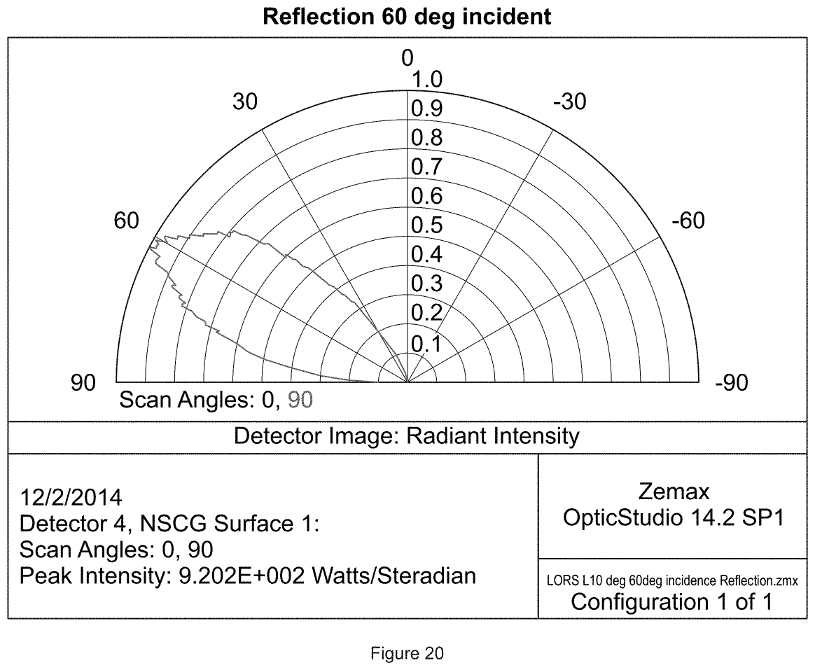

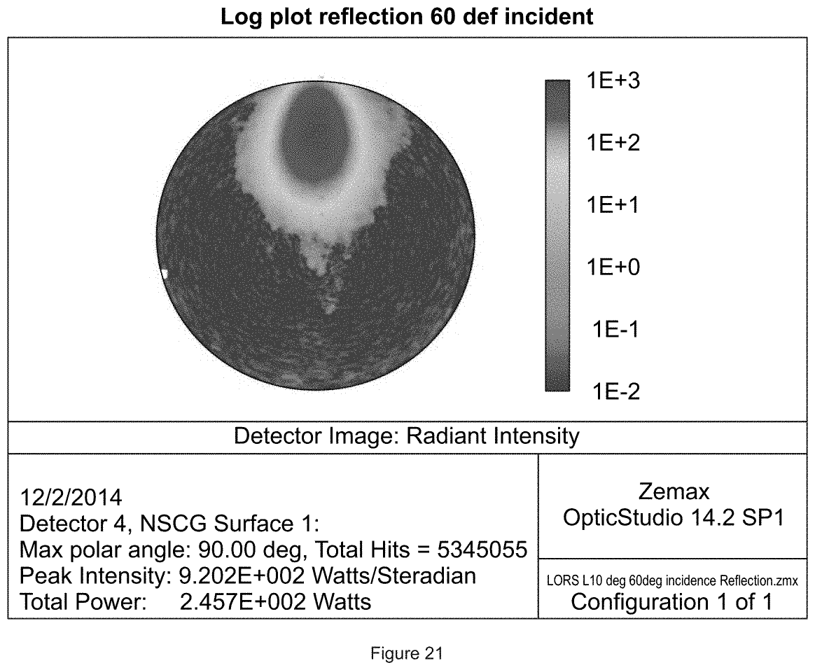

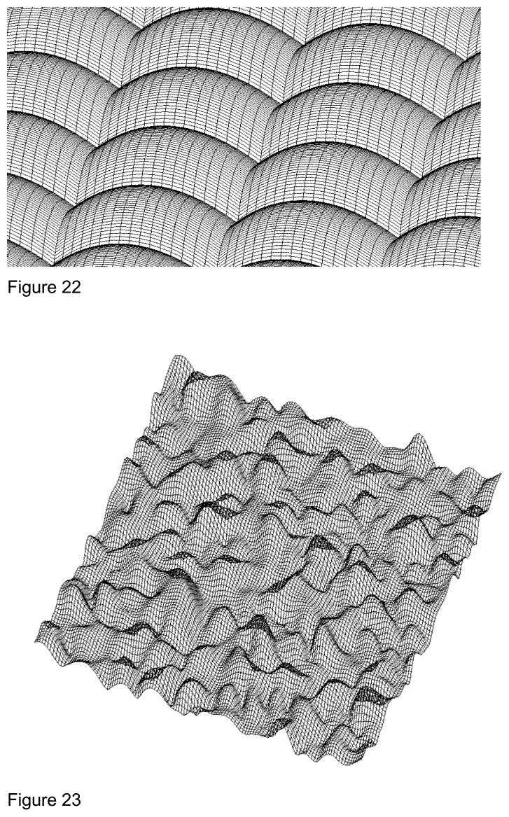

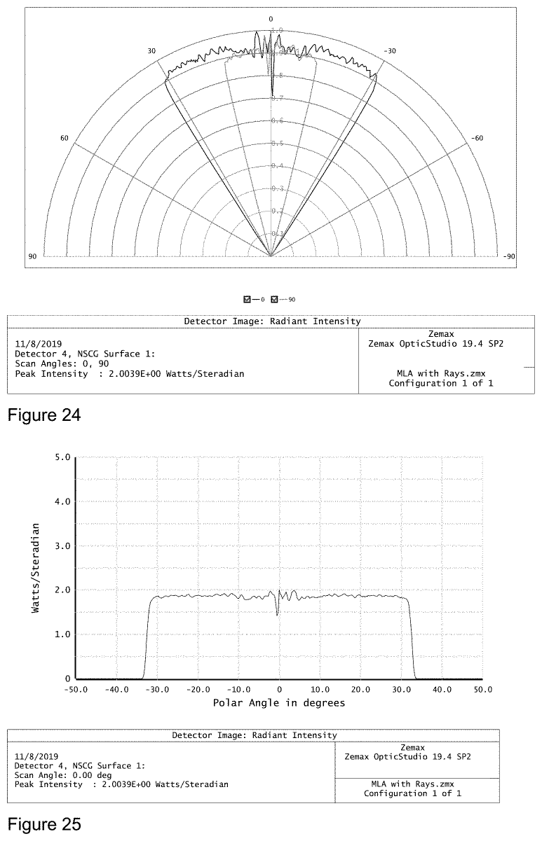

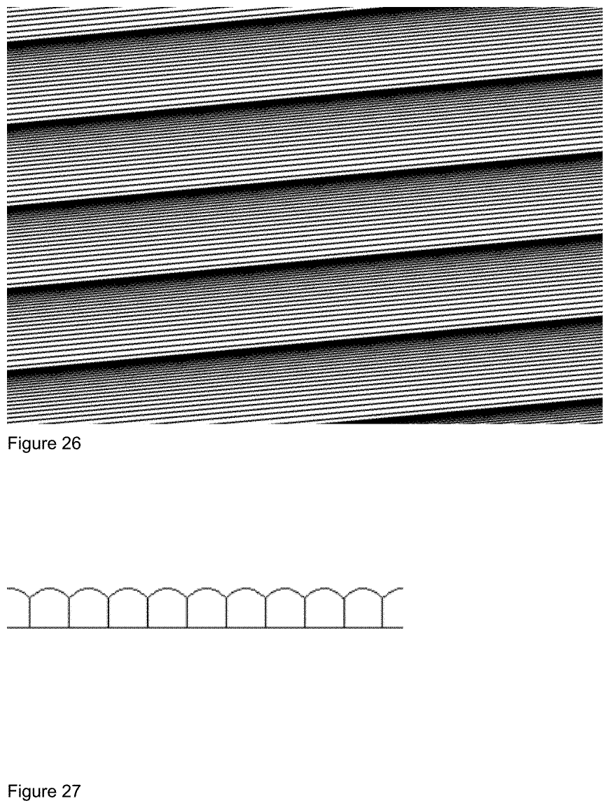

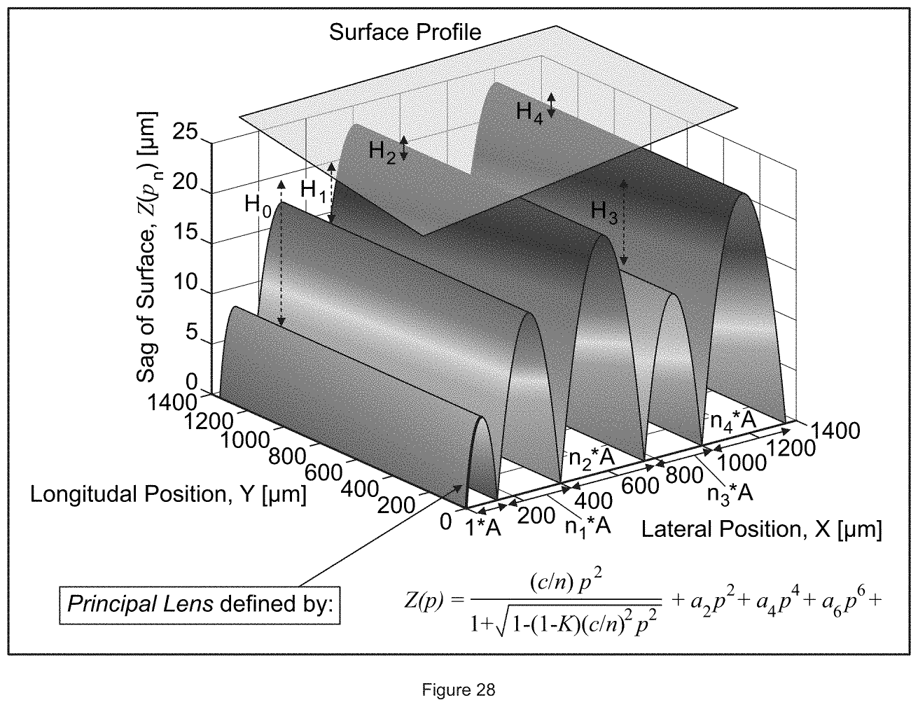

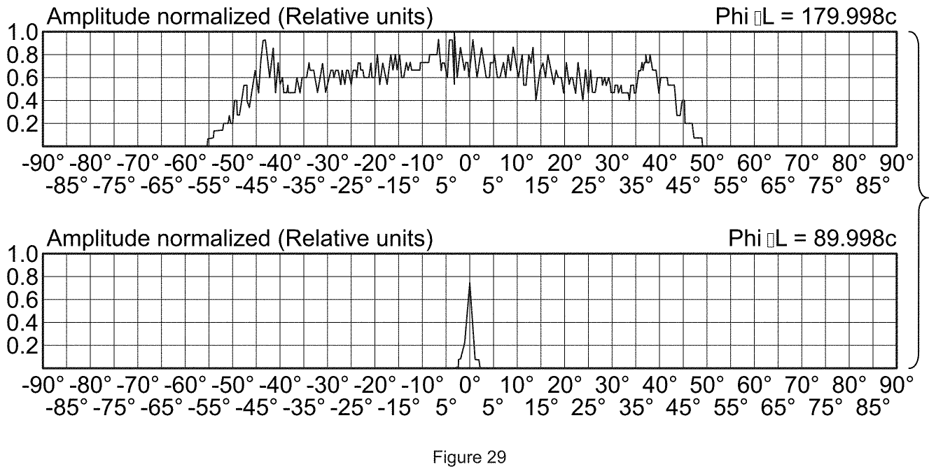

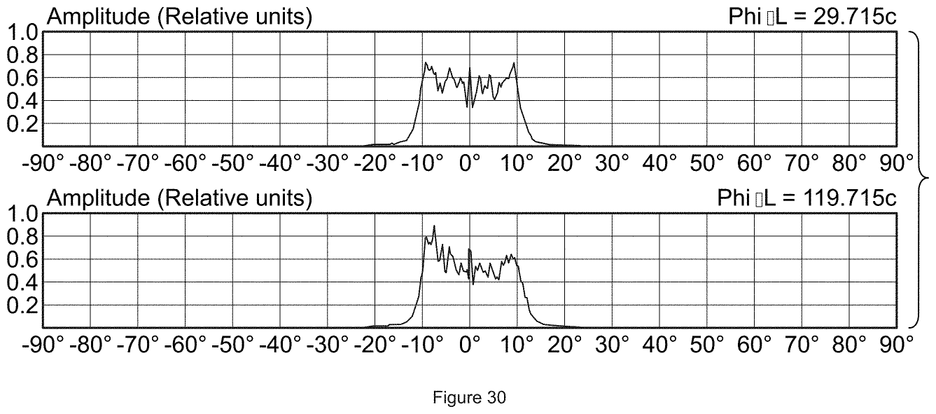

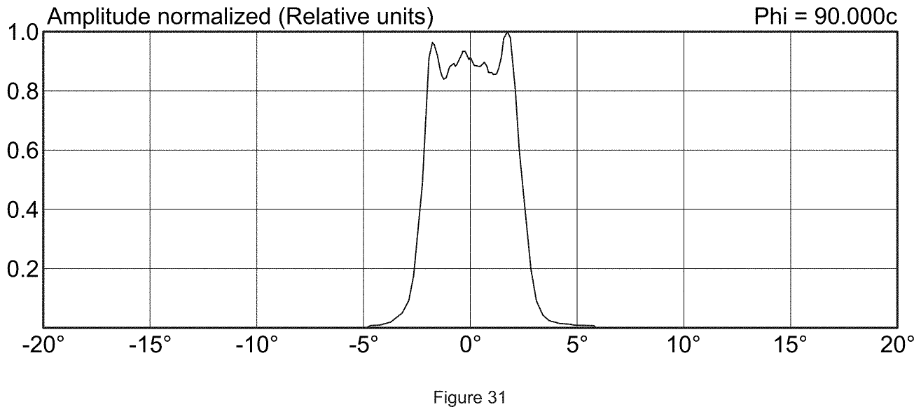

Several examples of the optical elements described herein are shown in the following Figures. One example of a micro lens array is shown in FIG. 12 depicting a Lenticular Lens Array. FIG. 13 shows Anamorphic Lens Array. FIG. 14 shows Texture Model of Light Shaping Diffuser. FIG. 15 shows Scanning Electron Microscope of Light Shaping Diffuser. FIG. 16 shows Microscope Image vs. Model. FIG. 17 shows Geometrical model in Zemax. FIG. 18 shows Off Axis incident. FIG. 19 shows Slice Plot in Zemax. FIG. 20 shows reflections 60 degrees incident. FIG. 21 shows a log plot reflection 60 degrees incident. One example of a micro lens array where all the lenses are the same size, shape, and spacing is in FIG. 22. FIG. 23 shows the wireframe depiction of the surface texture of a Light Shaping Diffuser, which acts as a randomizer for a regular micro lens array. FIG. 24 shows idealized distribution of 65×28 degrees fwhm radiant intensity plot using Ray Tracing program Zemax® depicting the idealized BSDF ray distribution utilizing Geometrical Optics to design. Diffraction Effects (diffraction orders) are not depicted. FIG. 25 shows an idealized slice plot of 65 degrees direction using the Ray Tracing program's Zemax® depiction of the idealized BSDF ray distribution utilizing Geometrical Optics to design. Diffraction Effects (diffraction orders) are not depicted. Plot format simulating Goniometer Plot of real Measured light distributions are shown. FIG. 26 shows a wireframe plot of Lenticular Array of lenses. The Wireframe diagram of the surface of a regularly spaced Lenticular Array of Lenses was produced on Zemax®. FIG. 27 shows the edge of a regular Lenticular Array of lenses with a Cross-sectional diagram of the surface of a regularly spaced Lenticular Array of Lenses, produced on Zemax®. FIG. 28 shows a Lenticular Array of lenses with variable scaled lenses. The lenticular set of lenses have variability in the scale size of the individual lenses in order to randomize the frequency. FIG. 29 shows a Figure of Measured Lenticular Flat Top Diffuser performance BSDF with some diffraction effects. Goniometer Measurement of Lenticular configuration diffuser. The Goniometer is an instrument which measures the BSDF (angular distribution of light). FIG. 30 shows a measured flat top diffuser performance as a Goniometer plot of real square 10×10 degrees fwhm and Flat top distribution. FIG. 31 shows a measured flat top diffuser performance as a Goniometer plot of real Flat top distribution. Only measurement in single direction is shown.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

1. An optical element comprising a micro lens array of lenslets and a randomizing function wherein both the micro lens array of lenslets and the randomizing function reside on the same surface of the optical element; wherein the micro lens array comprises identical lenslets arrayed in both an X and a Y direction; and wherein the randomizing function is an overlaid diffuser.

2. The optical element of claim 1 wherein distances of lens neighbor centers or pitch are identical in the X direction.

3. The optical element of claim 1 wherein distances of lens neighbor centers or pitch are identical in the Y direction.

4. The optical element of claim 1 wherein the optical element comprises a substrate comprising one or more layers comprising a plastic, a metal, a silicon wafer, or a glass plate.

5. The optical element of claim 1 wherein the metal substrate or reflective optical coating on a metal, a plastic, a silicon wafer, or a glass plate makes the diffusing element a reflective diffuser.

6. The optical element of claim 1 wherein a diffusion angle of the diffuser exceeds an order angle.

7. The optical element of claim 1 wherein the size of a lenslet ranges from about 1 micron to about 1 mm.

8. The optical element of claim 1 wherein the size of the micro array has an upper limit of about 500 mm by 300 mm or by tooling surface.

9. The optical element of claim 1 wherein a surface profile of the lenslet is functionally refractive, diffractive, transmissive or reflective.

10. The optical element of claim 1 wherein an individual lenslet sag ranges from about 1 micron to about 100 micron.

11. The optical element of claim 10 wherein the lenslet sag is spherical, parabolic, hyperbolic, ellipse, aspheric or biconic.

12. The optical element of claim 1 wherein the diffuser has a Gaussian function wherein distribution comprises 30 degrees full width half maximum or less.

13. The optical element of claim 1 wherein distribution comprises flat top, deterministic, super gaussian, line generator, batwing or asymmetric to achieve very high uniformity of light.

14. The optical element of claim 12 wherein the fullwidth at half maximum of the diffuser is greater than angular spacing of diffractive orders.

15. The optical element of claim 12 comprising a flat top diffuser with rectangular, square, elliptical, circular, hexagonal, and and/or other geometric shapes.

16. The optical element of claim 1 wherein the micro lens array is a lenticular lens array or an anamorphic lens array.

17. The optical element of claim 1 wherein the diffuser comprises a diffusing angle ranging from 5° to 80°.

18. An optical element comprising a refractive lens array and a diffuser wherein light utilization is maximized by directing light where needed and where light uniformity is increased by eliminating hot spots.

19. The optical element of claim 1 comprising convolution with a light shaping diffuser pattern.

20. The optical element of claim 1 wherein the micro lens array comprises convolving a comb function with a Gaussian function in angular space.

21. The optical element of claim 1 further comprising a coherent or incoherent light source whose emitted light is diffused, shaped, and customized by application of the optical element.
